(19) United States
(12) Patent Application Publication
(10) Pub. No.: US 2023/0087278 A1
(43) Pub. Date: Mar. 23, 2023

(54) GROUND MATERIAL IDENTIFICATION SYSTEM AND METHOD

(71) Applicant: Deere & Company, Moline, IL (US)

(72) Inventor: Lance R. Sherlock, Asbury, IA (US)

(21) Appl. No.: 17/448,106

(22) Filed: Sep. 20, 2021

(51) Int. Cl. E02F 9/26; E02F 3/84; G06K 9/00; G06N 3/04; G05B 19/418

(52) U.S. Cl. CPC E02F 9/261; E02F 3/84; G06K 9/00791; G06N 3/04; G05B 19/41875; E02F 3/7604

(57) ABSTRACT

A work vehicle that operates on a surface comprising an optical sensor. The optical sensor is configured to capture image data that includes a ground material. A non-transitory computer-readable memory is provided for storing operation information. An electronic processor is configured to receive image data captured by the optical sensor, apply an artificial neural network to identify a ground material characteristic based on the image data from the optical sensor, wherein the artificial neural network is trained to receive the image data as input and to produce as the output an indication of the ground material characteristic, access, from the non-transitory computer-readable memory, the operation information corresponding to the ground material characteristic, and adjust an operation of the work vehicle based on the accessed operation information corresponding to the ground material characteristic.

### FIELD OF THE DISCLOSURE

The present disclosure relates generally to ground material identification systems, and more particularly to a ground material identification control system and method for a work vehicle.

### BACKGROUND OF THE DISCLOSURE

Work vehicles, such as a crawler or motor grader, can be used in construction and maintenance for grading terrain to a flat surface at various angles, slopes, and elevations. When paving a road for instance, a motor grader can be used to prepare a base foundation to create a wide flat surface to support a layer of asphalt. When controlling a ground engaging tool, it is valuable to know the type of ground material on a surface. As such, there is a need in the art for an improved system and method that identifies the ground material on the surface.

### SUMMARY OF THE DISCLOSURE

According to one embodiment of the present disclosure, a method is disclosed. The method includes capturing image data with an optical sensor coupled to the work vehicle wherein, the image data includes a ground material. The method further includes identifying a ground material characteristic by processing the image data with an electronic processor, accessing, from a non-transitory computer-readable memory, operation information corresponding to the ground material characteristic, and adjusting an operation of the work vehicle based on the accessed operation information corresponding to the ground material characteristic.

A control system for a work vehicle that operates on a surface is disclosed. The control system comprises an optical sensor coupled to the work vehicle. The optical sensor is configured to capture image data that includes a ground material. A non-transitory computer-readable memory stores operation information. An electronic processor is configured to receive image data captured by the optical sensor, apply an artificial neural network to identify a ground material characteristic based on the image data from the optical sensor, wherein the artificial neural network is trained to receive the image data as input and to produce as the output an indication of the ground material characteristic, access, from the non-transitory computer-readable memory, the operation information corresponding to the ground material characteristic, and adjust an operation of the work vehicle based on the accessed operation information corresponding to the ground material characteristic.

According to another embodiment of the present disclosure, a work vehicle that operates on a surface is disclosed. The work vehicle comprises an optical sensor coupled to the work vehicle. The optical sensor is configured to capture image data that includes a ground material. A non-transitory computer-readable memory is provided for storing operation information. An electronic processor is configured to receive image data captured by the optical sensor, apply an artificial neural network to identify a ground material characteristic based on the image data from the optical sensor, wherein the artificial neural network is trained to receive the image data as input and to produce as the output an indication of the ground material characteristic, access, from the non-transitory computer-readable memory, the operation information corresponding to the ground material characteristic, and adjust an operation of the work vehicle based on the accessed operation information corresponding to the ground material characteristic.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 is a perspective view of a work vehicle according to an embodiment;

FIG. 2 is a side view of a work vehicle according to another embodiment;

FIG. 3 is a block diagram of a ground material identification system according to an embodiment; and

FIG. 4 is a flow diagram of a method for operating a work vehicle on a surface.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Further embodiments of the invention may include any combination of features from one or more dependent claims, and such features may be incorporated, collectively or separately, into any independent claim.

### DETAILED DESCRIPTION OF THE DRAWINGS

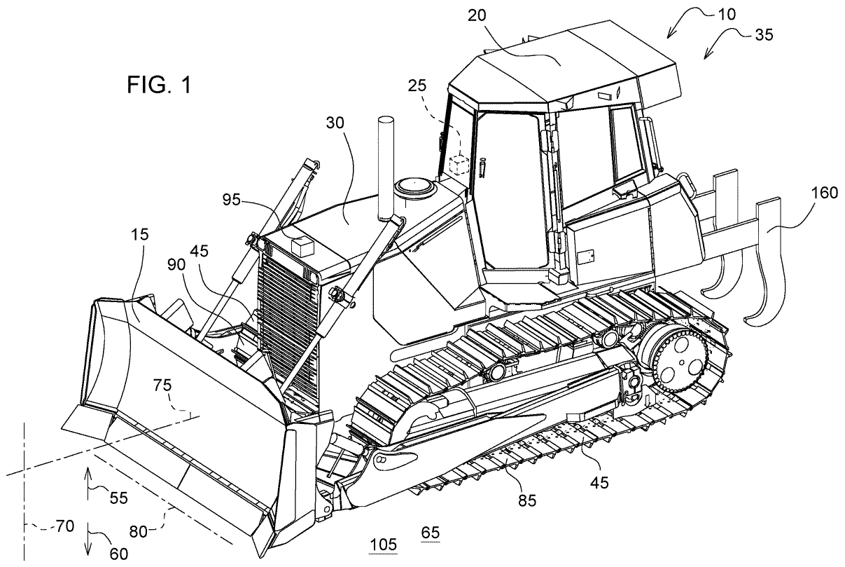

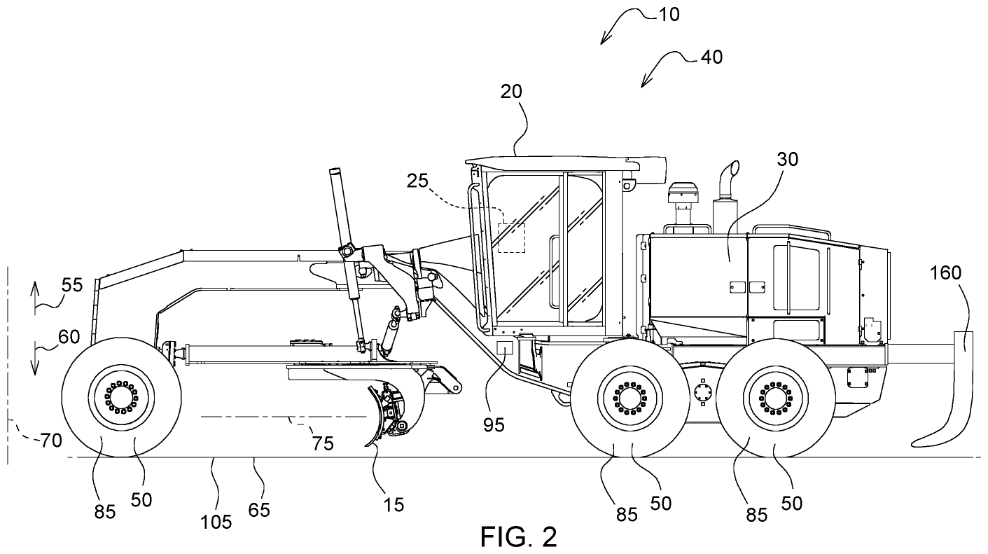

FIGS. 1 and 2 illustrate a work vehicle 10 having an implement 15, an operator station 20 having an operator interface 25, and an engine 30. The work vehicle 10 may be any work vehicle 10 to which the implement 15 may be coupled, such as a crawler 35 or a motor grader 40, to name a few examples. The work vehicle 10 may be controlled by an operator located in the operator station 20 or by an operator located at a remote location (not shown) from the work vehicle 10. The operator may command the work vehicle 10 to move forward, move backward, and turn. Those commands are sent to hydraulic pumps, driven by the engine 30, which direct pressurized hydraulic fluid to hydraulic motors that turn tracks 45 or wheels 50. The engine 30 may be a diesel engine. Alternatively, the tracks 45 or wheels 50 may be turned by electric motors.

The implement 15 may be positioned at a front of the work vehicle 10 and may be attached to the work vehicle 10 in a number of different manners. In this embodiment, the implement 15 is attached to the work vehicle 10 through a linkage which includes a series of pinned joints, structural members, and hydraulic cylinders. This configuration allows the implement 15 to be moved up 55 and down 60 relative to a surface 65 or ground, rotate around a vertical axis 70 (i.e., an axis normal to the ground), rotate around a longitudinal axis 75 (e.g., a fore-aft axis of the work vehicle 10), and rotate around a lateral axis 80 of the work vehicle 10 (i.e., a left-right axis of the work vehicle 10). These degrees of freedom permit the implement 15 to engage the ground at multiple depths and cutting angles. Alternative embodiments may involve implements 15 with greater degrees of freedom, such as those found on some motor graders 40, and those with fewer degrees of freedom, such as “pushbeam” style blades found on some crawlers 35 and implements 15 which may only be raised, lowered, and rotated around a vertical axis as found on some excavators and skidders.

The operator may command movement of the implement 15 from the operator station 20, which may be coupled to the work vehicle 10 or located remotely. In the case of the work vehicle 10, those commands are sent, including mechanically, hydraulically, and/or electrically, to a hydraulic control valve. The hydraulic control valve receives pressurized hydraulic fluid from a hydraulic pump, and selectively sends such pressurized hydraulic fluid to a system of hydraulic cylinders based on the operator's commands. The hydraulic cylinders, which in this case are double-acting, in the system are extended or retracted by the pressurized fluid and thereby actuate the implement 15. Alternatively, electronic actuators may be used.

With reference to FIG.1, the illustrated work vehicle 10 is a crawler 35 for moving material. The crawler 35 includes tracks 45 including a left track 85 and a right track 90. As used herein, “left” and “right” refer to the left and right sides of the operator when the operator is sitting within the operator station 20 that is coupled to the work vehicle 10 and facing the implement 15.

Referring to FIG. 2, the illustrated work vehicle 10 is a motor grader 40 for spreading and leveling dirt, gravel, or other materials. The motor grader 40 includes wheels 50 including a plurality of left wheels 85 (right wheels not shown).

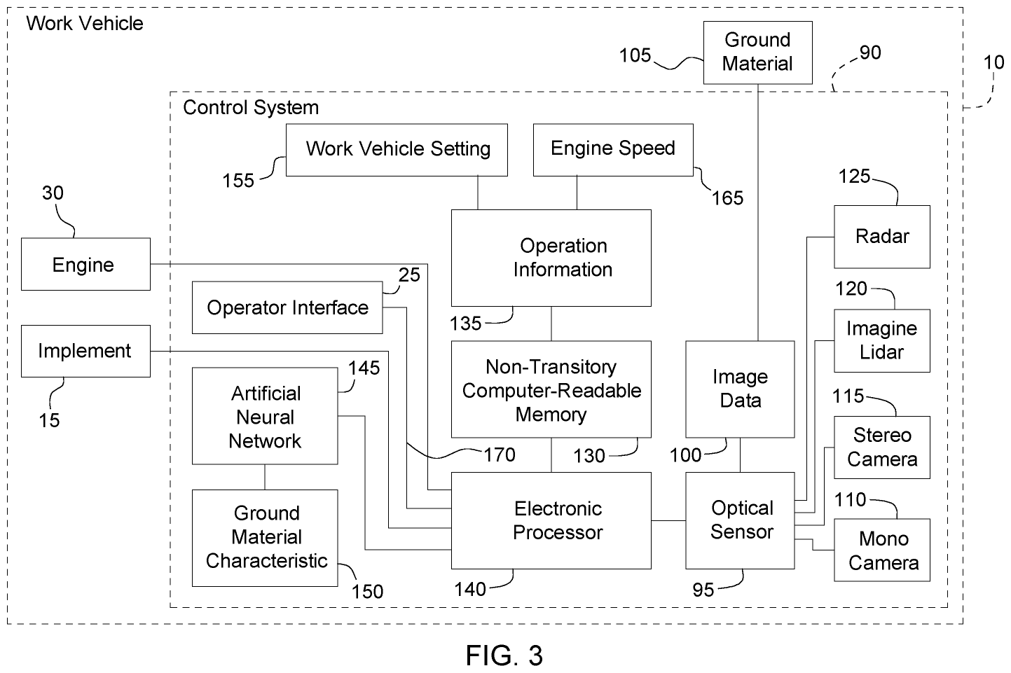

With reference to FIG. 3, the work vehicle 10 has a control system 90. The control system 90 includes an optical sensor 95 coupled to the work vehicle 10. The optical sensor 95 may be configured to capture image data 100 that includes a ground material 105 on the surface 65. The optical sensor 95 may comprise either a mono camera 110 or a stereo camera 115. Alternatively, the optical sensor 95 may comprise imaging lidar 120 or radar 125.

The control system 90 also has a non-transitory computer-readable memory 130 that stores operation information 135. The non-transitory computer-readable memory 130 may comprise electronic memory, nonvolatile random-access memory, an optical storage device, a magnetic storage device, or another device for storing and accessing electronic data on any recordable, rewritable, or readable electronic, optical, or magnetic storage medium.

An electronic processor 140 is provided. The electronic processor 140 may be arranged locally as part of the work vehicle 10 or remotely at a remote processing center (not shown). In various embodiments, the electronic processor 140 may comprise a microprocessor, a microcontroller, a central processing unit, a programmable logic array, a programmable logic controller, other suitable programmable circuitry that is adapted to perform data processing and/or system control operations.

The electronic processor 140 is configured to receive image data 100 captured by the optical sensor 95 and apply an algorithm of an artificial neural network 145 to identify a ground material characteristic 150 of the ground material 105, based on the image data 100 from the optical sensor 95. The artificial neural network 130 is trained to receive the image data 100 as input and to produce as the output an indication of the ground material characteristic 150.

The ground material characteristic 150 may be a classification of the ground material 105 such as gravel, rock, sand, clay, water, top soil, or other material and the depth or volume of that material. The ground material characteristic 150 may also be a determination of whether the ground material 105 is compactable or otherwise usable for a work vehicle 10 operation. The ground material characteristic 150 may be a determination of the topography including holes, slopes, elevation, objects, or other topographic features.

The electronic processor 140 accesses the operation information 135 corresponding to the ground material characteristic 150 from the non-transitory computer-readable memory 130 and adjusts an operation of the work vehicle 10 based on the accessed operation information 135 corresponding to the ground material characteristic 150. The operation information 135 may include a change to a work vehicle setting 155 such as a depth of the implement 15, a depth of a ripper 160 (FIG. 1), or an engine speed 165, or other. The operation information 135 may further include continuing to operate the work vehicle 10 with no change, stopping the work vehicle 10, or transitioning the work vehicle 10 to another operation such as going from ripping with the ripper 160 to grading with the implement 15 or other operation (e.g., leveling, transport). The operation information 135 may include communicating a signal 170 that is indicative of a phase of a job or operation that is occurring, the ground material characteristic 150, a productivity of the work vehicle 10 (e.g., work accomplished per gallon of fuel, amount of material moved per hour), another work vehicle 10 is needed (e.g., grader is needed, crawler is needed), ora needed ground material 105 (e.g., gravel, sand, clay, dirt). The signal 170 may be received by the remote location or by the operator interface 25. The operator interface 25 may display the ground material characteristic 150.

The adjustment may include implementing the operation information 135 on the work vehicle 10 for the given ground material characteristic 150 including adjusting a position of the implement 15 relative to the work vehicle 10, transitioning the control of the work vehicle 10 between a manual control 175 where the operator controls the machine and an automatic control 180, moving the implement 15 up 55 or down 60 to change the depth of the implement 15, moving the ripper 160 up 55 or down 60 to change the depth of the ripper 160, or changing the engine speed 165 of the engine 30.

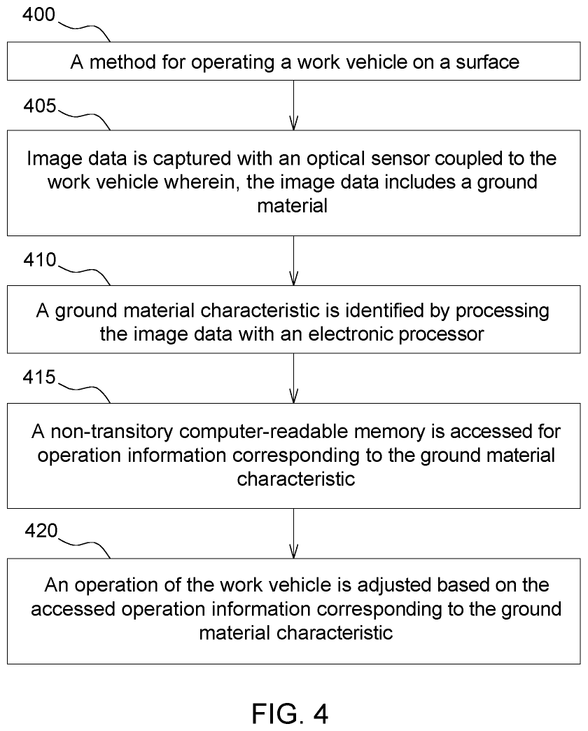

Referring now to FIG. 4, a flow diagram of a method 400 for operating a work vehicle 10 on a surface 65 is shown. At 405, image data 100 is captured with an optical sensor 95 coupled to the work vehicle 10 wherein, the image data 100 includes a ground material 105. At 410, a ground material characteristic 150 is identified by processing the image data 100 with an electronic processor 140. At 415, a non-transitory computer-readable memory 130 is accessed for operation information 135 corresponding to the ground material characteristic 150. At 420, an operation of the work vehicle 10 is adjusted based on the accessed operation information 135 corresponding to the ground material characteristic 150.

What is claimed is:

1. A method of operating a work vehicle on a surface, the method comprising:
capturing image data with an optical sensor coupled to the work vehicle wherein, the image data includes a ground material;
identifying a ground material characteristic by processing the image data with an electronic processor;
accessing, from a non-transitory computer-readable memory, operation information corresponding to the ground material characteristic; and
adjusting an operation of the work vehicle based on the accessed operation information corresponding to the ground material characteristic.

2. The method of claim 1, wherein the adjusting the operation of the work vehicle comprises changing a vehicle setting and continuing to operate the work vehicle, stopping the work vehicle, or transitioning the work vehicle to another operation.

3. The method of claim 2, wherein the adjusting the operation of the work vehicle further comprises communicating a signal.

4. The method of claim 3, wherein the signal is indicative of a phase of a job that is occurring, the ground material characteristic, a productivity of the work vehicle, another work vehicle is needed, or a needed ground material.

5. The method of claim 1, wherein the optical sensor comprises at least one of a stereo camera or a mono camera.

6. The method of claim 1, wherein the ground material characteristic is displayed on an operator interface.

7. The method of claim 2, wherein the vehicle setting comprises a blade depth, a ripper depth, or an engine speed.

8. The method of claim 1, wherein identifying the ground material characteristic by processing the image data comprises:
providing the image data as an input to an artificial neural network, wherein the artificial neural network is trained to receive as the input, image data including the ground material, and to produce as an output, an indication of the ground material characteristic; and
receiving an indication of the identification of the ground material characteristic as the output of the artificial neural network.

9. A control system for a work vehicle that operates on a surface, the control system comprising:
an optical sensor coupled to the work vehicle, the optical sensor configured to capture image data that includes a ground material;
a non-transitory computer-readable memory storing operation information; and
an electronic processor configured to:
receive image data captured by the optical sensor,
apply an artificial neural network to identify a ground material characteristic based on the image data from the optical sensor, wherein the artificial neural network is trained to receive the image data as input and to produce as the output an indication of the ground material characteristic,
access, from the non-transitory computer-readable memory, the operation information corresponding to the ground material characteristic, and
adjust an operation of the work vehicle based on the accessed operation information corresponding to the ground material characteristic.

10. The control system of claim 9, wherein adjusting the operation of the work vehicle comprises changing a vehicle setting and continuing to operate the work vehicle, stopping the work vehicle, or transitioning the work vehicle to another operation.

11. The control system of claim 10, wherein the adjusting the operation of the work vehicle further comprises communicating a signal.

12. The control system of claim 11, wherein the signal is indicative of a phase of a job that is occurring, the ground material characteristic, a productivity of the work vehicle, another work vehicle is needed, or a needed ground material.

13. The control system of claim 9, wherein the optical sensor comprises at least one of a stereo camera or a mono camera.

14. The control system of claim 9, wherein the ground material characteristic is displayed on an operator interface.

15. The control system of claim 10, wherein the vehicle setting comprises a blade depth, a ripper depth, or an engine speed.

16. A work vehicle that operates on a surface, the work vehicle comprising:
an optical sensor coupled to the work vehicle, the optical sensor configured to capture image data that includes a ground material;
a non-transitory computer-readable memory storing operation information; and
an electronic processor configured to:
receive image data captured by the optical sensor,
apply an artificial neural network to identify a ground material characteristic based on the image data from the optical sensor, wherein the artificial neural network is trained to receive the image data as input and to produce as the output an indication of the ground material characteristic,
access, from the non-transitory computer-readable memory, the operation information corresponding to the ground material characteristic, and
adjust an operation of the work vehicle based on the accessed operation information corresponding to the ground material characteristic.

17. The work vehicle of claim 16, wherein adjusting the operation of the work vehicle comprises changing a vehicle setting and continuing to operate the work vehicle, stopping the work vehicle, or transitioning the work vehicle to another operation.

18. The work vehicle of claim 17, wherein the adjusting the operation of the work vehicle further comprises communicating a signal.

19. The work vehicle of claim 18, wherein the signal is indicative of a phase of a job that is occurring, the ground material characteristic, a productivity of the work vehicle, another work vehicle is needed, or a needed ground material.

20. The work vehicle of claim 17, wherein the vehicle setting comprises a blade depth, a ripper depth, or an engine speed.
